(19) United States
(12) Patent Application Publication
(10) Pub. No.: US 2021/0366020 A1
(43) Pub. Date: Nov. 25, 2021

(54) SYSTEM AND METHOD FOR A PERSONALISED LOOK-BOOK CREATION IN REAL-TIME

(71) Applicant: Govind Balakrishna Raju, BANGALORE (IN)

(72) Inventor: Govind Balakrishna Raju, BANGALORE (IN)

(21) Appl. No.: 16/340,374

(22) PCT Filed: Nov. 26, 2018
(86) PCT No.: PCT/IB2018/059291

§ 371 Date: Apr. 8, 2019

(30) Foreign Application Priority Data
Aug. 28, 2018 (IN) 201841032235

(51) Int. Cl. G06Q 30/06

(52) U.S. Cl. CPC G06Q 30/0631; G06Q 30/0641

(57) ABSTRACT

System and method for a personalised look-book creation in real-time are provided. The system includes a storage module configured to receive and store stylist data of corresponding plurality of stylists, a selection module configured to enable at least one customer to select at least one stylist from the stylist data of the plurality of stylists stored in the storage module, a chat module configured to enable the at least one customer and at least one selected stylist to exchange one or more recommendations in real-time to select one or more products, a look-book module configured to enable the at least one customer to create a personalised look-book upon selection of the one or more products and a display interface configured to display the personalised look-book created by the at least one customer in real-time.

### CROSS-REFERENCE TO RELATED APPLICATION

This application claims the benefit of PCT Application bearing application no. PCT/IB2018/059291, filed on Nov. 26, 2018 and Complete Patent Application bearing application no. 201841032235, filed on Aug. 28, 2018 in India.

### BACKGROUND

Embodiments of the present disclosure relate to look-book creation and more particularly to a system and method for a personalised look-book creation in real-time.

A look-book is a collection of photographs which is used to present a model, a photographer, trending style, a stylist, clothing line or the like. Further, with the help of the look-book, customers or viewers can keep a track of a plurality of details in a world of fashion. Also, different types of systems are used to create different types of look-book.

In one approach, a system provides an electronic network platform through which customers or viewers can select one or more products by viewing a list of available products offered by a specific brand or a specific company. Moreover, in such system, the look-book can be created by selecting the one or more products which are offered by the specific brand only. Such restriction to create the look-book confines the customers' fashion to the specific brand. Further, the platform provides a recommendation assistance from friends, stylists, advisers or the like. However, such recommendation does not happen in real-time. Also, the customers cannot select stylists of their choices.

In another approach, the system includes an input module which allows the customers to select the one or more products offered by corresponding one or more retailers. Further, on selection of the one or more products, the customers can ask for a recommendation on a platform through an interface about the selected one or more products. Moreover, one or more uses can recommend the customers for the one or more products selected which can be viewed by a plurality of other customers or a plurality of other viewers. Also, based on the recommendation, the customer can create a new look-book for the one or more products selected. However, the recommendation from the one or more user are not in real-time. Also, the customer cannot directly interact with the one or more users for further recommendation which the customer do not feel feasible to share with the plurality of other customers on an open platform. In addition, the look-book which is created by the customer cannot be shared with the plurality of other customers or the one or more users in real time. Furthermore, the system does not allow an omni-channel medium to couple with a plurality of offline retails which makes the system less reliable, less efficient and time consuming.

Hence there is a need of an improved system and method for a personalised look-book in real-time creation to address the aforementioned issues.

### BRIEF DESCRIPTION

In accordance with one embodiment of the disclosure, a system for a personalised look-book creation is provided. The system includes a storage module. The storage module is configured to receive and store stylist data of corresponding plurality of stylists. The system also includes a selection module operatively coupled to the storage module. The selection module is configured to enable at least one customer to get in contact with at least one stylist from the stylist data of the plurality of stylists stored in the storage module. The system further includes a chat module operatively coupled to the selection module. The chat module is configured to enable the at least one customer and at least one selected stylist to exchange one or more recommendations in real-time to select one or more products. Further, the one or more products are offered by corresponding one or more retailers. The system further includes a look-book module operatively coupled to the chat module. The look-book module is configured to enable the at least one customer to create a personalised look-book upon selection of the one or more products. The system further includes a display interface operatively coupled to the look-book module. The display interface is configured to display the personalised look-book created by the at least one customer in real-time.

In accordance with another embodiment of the disclosure, a method for creating a personalised look-book is provided. The method includes receiving and storing stylist data of corresponding plurality of stylists. The method also includes enabling at least one customer to get in contact with at least one stylist from the stylist data of the plurality of stylists stored in the storage module. The method further includes enabling the at least one customer and at least one selected stylist to exchange one or more recommendations in real-time to select one or more products. The method further includes enabling the at least one customer to create a personalised look-book upon selection of the one or more product. The method further includes displaying the look-book created by the at least one customer in real-time.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for a personalised look-book creation in accordance with an embodiment of the present disclosure:

FIG. 2 is a block diagram representation of an exemplary embodiment of a system for a customer to create a personalised look-book creation of FIG. 1 in accordance with an embodiment of the present disclosure; and

FIG. 3 is a flow chart representing steps involved in a method for creating a personalised look-book in real-time in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”. “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for a personalised look-book creation are disclosed. The system includes a storage module. The storage module is configured to receive and store stylist data of corresponding plurality of stylists. The system also includes a selection module operatively coupled to the storage module. The selection module is configured to enable at least one customer to get in contact with at least one stylist from the stylist data of the plurality of stylists stored in the storage module. The system further includes a chat module operatively coupled to the selection module. The chat module is configured to enable the at least one customer and at least one selected stylist to exchange one or more recommendations in real-time to select one or more products. Further, the one or more products are offered by corresponding one or more retailers. The system further includes a look-book module operatively coupled to the chat module. The look-book module is configured to enable the at least one customer to create a personalised look-book upon selection of the one or more products. The system further includes a display interface operatively coupled to the look-book module. The display interface is configured to display the personalised look-book created by the at least one customer in real-time.

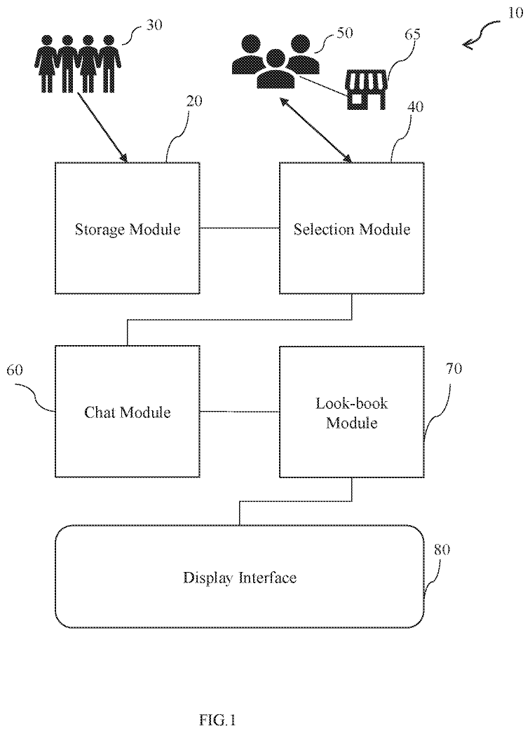

FIG. 1 is a block diagram (10) representation of a system (10) for a personalised look-book creation in real-time in accordance with an embodiment of the present disclosure. The system (10) includes a storage module (20). The storage module (20) is configured to receive and store stylist data of corresponding plurality of stylists (30). In one embodiment, the storage device (20) may be configured to receive and store customer data and user data of corresponding one or more customers and one or more user respectively. In one exemplary embodiment, the storage module (20) may be a storage on a remote server. In such embodiments, the remote server may be a cloud server. In another embodiment, the storage module (20) may be a hard disk, a random-access memory (RAM), a cache memory, a read only memory (ROM) or any external memory. In such embodiment, the storage device (20) may be operatively coupled to a computer device. In one embodiment, the computer device may be a hand-held device. In yet another embodiment, the storage module (20) may be stored on a local server. In such embodiment, the hand-held device may include a mobile phone, a tablet or a laptop.

In one specific embodiment, the storage module (20) may also be configured to receive and store customer data from corresponding at least one customer (40). As used herein, a stylist is a person who has mastered in a specific field. In such embodiment, the plurality of stylists may include at least one of a fashion community, one or more users and the one or more customers. In one embodiment, the fashion community may include but not limited at least one of a designer, a content writer, a stylist, an academia, a retailer and models. Also, a customer is a person who may or may not pay the stylists for one or more goods or one or more services. In one embodiment, the stylist data may include but not limited to at least one of a name, an age, a place of living, a photo, a list of customers, years of experience, a collection of work, social profile details or the like of the corresponding plurality of stylists (30). In another embodiment, the customer data may include at least one of a name, an age, a place of living, at least one requirement, a photo or the like of the corresponding at least one customer (50). In such embodiment, the stylist data may further include personal, general and social profile associated with the at least one stylist (30). In such another embodiment, the customer data may further include personal, general and social profile associated with the at least one customer (50). In one specific embodiment, the stylist data may include information which may consist the customer data and information.

In one embodiment, the plurality of stylists (30) may include people, fashion community, users, customers or retailers who may be consultants who may select one or more products for their customers. In such embodiments, the plurality of stylists (30) may be a plurality of fashion stylists or a plurality of wardrobe stylists who may select or recommend clothing of a latest trend or a latest fashion to their customers. In another embodiment, the plurality of stylists (30) may include one or more friends or one or more family members of the corresponding at least one customer (50).

In one exemplary embodiment, the storage module (20) may further be configured to receive and store retailer data of corresponding one or more retailers (65). In one embodiment, the retailer data may include at least one of a name, at least one product or at least one service offered by the corresponding one or more retailers (65). In such embodiments, the one or more retailers (65) may display or showcase the at least one product or the at least one service offered to at least one of the one or more users or the one or more customers. In one specific embodiment, the one or more retailers (65) may offer a plurality of clothing. In such embodiment, the one or more retailers (65) may offer but just limited clothing for men, women and children. In one embodiment, the one or more retailers (65) may, be a company or a brand offering the plurality of clothing. In another embodiment, the one or more retailers (65) may be one or more online retailers. In yet another embodiment, the one or more retailers (65) may be one or more offline retailers. In yet another embodiment, the one or more retailers (65) may correspond to at least one of a clothing line and accessories, a marketplace and an ecommerce platform.

Furthermore, the system (10) includes a selection module (40) operatively coupled to the storage module (20). The selection module (20) is configured to enable at least one customer (50) to get in contact with at least one stylist (30) from the stylist data of the plurality of stylists (30) be stored in the storage module (20). In one embodiment, the at least one customer (50) may be in need of one or more suggestions or one or more recommendations from at least one stylist (30) to select or design clothing for the at least one customer (50). In one embodiment, the at least one customer (50) may by choice select the at least one stylist (20) from the list of the plurality of stylists (30). In another embodiment, the at one customer may be connected with the at least one stylist (30) automatically by the system (10) based on a pre-defined data which may be associated with the at least one customer (50). More specifically, the at least one stylist (20) may be randomly selected or randomly generated by the system (10) to assist the at least one customer (50). In such embodiment, the at least one customer (50) may select or connect to the at least one stylist (30) from the stylist data which may be stored in the storage module (20).

In one embodiment, the stylist data may include a list of the plurality of stylists (30) who may be available for the at least one customer (50) to assist the at least one customer (50) based on one or more requirements of the at least one customer (50). In such embodiment, the at least one customer (50) may select the at least one stylist (30) through a display which may be configured to display the stylist data and a list of the plurality of stylists (30). In one embodiment, the display may be operatively coupled to a computer device. In another embodiment, the computer device may be a hand-held device such as a mobile phone or a tablet. In another embodiment, the computer device may be a portable device such as a laptop. In yet another embodiment, the computer device may be a desktop. In yet another embodiment, the plurality of stylists may connect to the one or more users or the one or more customers through a web page, a mobile application a web application or a website via the computer device.

Consequently, the at least one customer (50) may select the at least one stylist (30) and may send a request to the at least one stylist (30) for the one or more recommendations. In such embodiment, the one or more recommendations may be to create a look-book for the at least one customer (50). As used herein, the look-book is a set of photographs which displays a collection of the one or more products. In one embodiment, the look-book may be created by the at least one customer (50) to display a collection of clothing of a latest fashion otherwise any clothing, footwear, accessories.

Furthermore, the system (10) includes a chat module (60) operatively coupled to the selection module (40). The chat module (60) is configured to enable the at least one customer (50) and at least one selected stylist to exchange one or more recommendations in real-time to select the one or more products, wherein the one or more products are offered by the corresponding one or more retailers (65). In one embodiment, based on the request of the at least one customer (50), the at least one stylist (30) may agree to provide the one or more recommendations for the at least one customer (50).

Subsequently, the at least one stylist (30) and the at least one customer (50) may exchange the one or more recommendations through the chat module (60) in real-time. In one exemplary embodiment, the chat module (60) may be operatively coupled to a customer interface and a stylist interface, wherein the customer interface may be operated by the at least one customer (50) and the stylist interface may be operated by the at least one stylist. In such embodiment, the customer interface and the stylist interface may be operatively coupled through an omni-channel medium. As used herein, the omni-channel medium is defined as a type of cross channel relating to a type of retail to integrate a plurality of methods of shopping which are available to the customers. In one specific embodiment, the omni-channel medium may provide a communication platform between the at least one customers, the at least one stylist (30) and the one or more retailers (65), wherein the one or more retailers (65) may be the one or more offline retailers (65) or one or more online market place.

Furthermore, based on the one or more recommendations given by the at least one stylist (30), the at least one customer (50) may select the one or more products from the corresponding one or more retailers (65). In such embodiment, the at least one customer (50) may select the one or more products through the selection module (40). In such embodiment, the selection module (40) may be available on at least one of the online market place and the offline stores. In such embodiment, the offline stores representative of the at least one retailer (65) may give a personalised recommendation look or the look book or a curated look to the at least one customer (50) with or without interference of the fashion community or the at least one stylist (30). In such embodiment, the look book may be created via an offline store or a retail inventory by engaging the at least one retailer (65), one or more communities, the one or more users or the one or more customers (50).

In addition, the system (10) further includes a look-book module (70) operatively coupled to the chat module (60). The look-book module (70) is configured to enable the at least one customer (50) to create a personalised look-book upon selection of the one or more products. In one embodiment, the at least one customer (50) may create a look-book based on the one or more recommendations which may be provided by the at least one stylist (30). In such embodiment, the at least one customer (50) may share the look-book with the at least one stylist (30) in real-time through the chat module.

Furthermore, the system (10) includes a display interface (80) operatively coupled to the look-book module (70). The display interface is configured to display the personalised look-book created by the at least one customer (50) in real-time. In one embodiment, the display interface (80) may be operatively coupled to the hand-held device. In such embodiment, the hand-held device may be the mobile phone or the tablet.

In one specific embodiment, the system (10) may be located on the remote server. In such embodiment, the remote server may be the cloud server. Furthermore, in one embodiment, the at least one customer (50) may share the look-book on an open platform. In one such embodiment, the open platform may be available to the plurality of stylists (30). In another embodiment, the open platform may be available to public or a plurality of customers of the corresponding at least one retailer, wherein the public may be able to view the latest fashion or latest trend with respect to the corresponding one or more products. In one specific embodiment, the public may be able to view the look-book which may include a collection of the latest fashion clothing which may be created by the at least one customer (50) based on the one or more recommendations of the at least one stylist (30).

In one exemplary embodiment, the one or more users or the at least one customer (50) may further recommend to one or more other customers. More specifically, the at least one customer (50) may become a stylist for the one or more other users in future.

In one specific embodiment, the at least one customer (50) may be a regular customer for the corresponding one or more retailers (65). Further, in a situation where the at least one customer (50) may be in need of a specific type of a clothing. Consequently, the one or more retailers (65) may reserve the specific type of the clothing for the at least one customer (50).

In one exemplary embodiment, at a situation, the one or more users, the one or more customers (50), the at least one retailer (65) or the fashion community may all be representative of the at least one customer (50) to whom the at least one stylist (30) may recommend the look book. In another exemplary embodiment, the at least one customer (50) and the at least one stylist (30) may exchange the look book via at least one of one to one, one to many, may to many or many to one accordingly.

In one exemplary embodiment, the personalized look books may be automatically created or generated in real time which may be made with the help of at least one of a machine learning model, an artificial intelligence technique, or technology which may be automatically created via a mobile phone, a website, a web page, a tablet, outdoor digital board, a digital medium, a virtual reality (VR) device, an augmented reality (AR) device or the like.

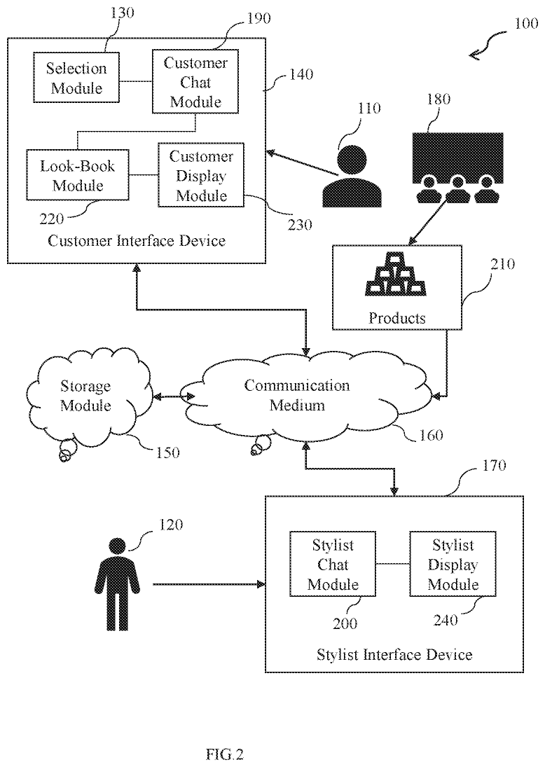

FIG. 2 is a block diagram representation (100) of an exemplary embodiment of a system (100) for a customer to create a personalised look-book creation of FIG. 1 in accordance with an embodiment of the present disclosure. A customer X (110) wants to buy clothes and hence need an advice and recommendation from a stylist Z (120). Further, the customer X (110) searches a list of stylists who may be registered on a platform or may be provided by the users, a customer, a community, a retailer on a random basis based on availability or presence. The customer X (110) finds the stylist Z (120) on the list through a selection module (130) of a customer interface device (140) and sends a request to the stylist Z (120), wherein the list of a plurality of stylists are stored in a storage module (150). The storage module (150) is communicatively coupled to the customer interface device (140) through a communication medium (160).

Further based on the request sent by the customer X (110), the stylist Z (120) accepts the request and accepts to render the advice and the recommendation for the customer X (110) to select the clothes through a stylist interface device (170) based on certain pre-defined data which is associated with the customer X (110). In addition, the storage module (150) is also communicatively coupled to the stylist interface device (170) through the communication medium (160). Subsequently, the customer X (110) and the stylist Z (120) starts to exchange the recommendation for the selection of the clothes. In addition, the clothes (210) are offered by the company Y (180). Furthermore, the customer X (110) and the stylist Z (120) exchange the recommendation through a customer chat module (190) and a stylist chat module (200) respectively. Furthermore, based on the recommendation of the stylist Z (120), the customer X (110) selects the cloths offered by the company Y (180). In addition, the company Y (180) showcases the clothes (210) offered through the communication medium (160). Also, the customer X (110) and the stylist Z (120) can view the clothes through the customer interface device (140) and the stylist interface device (170) respectively.

Consequently, on selecting the clothes offered by the company Y (180), the customer X (110) creates a personalised look-book through a look-book module (220) which is operatively coupled to the customer chat module (190). Furthermore, the customer X (110) shares look-book with the stylist Z (120) in real-time through a customer display module (230) which is operatively coupled to the look-book module (220) of the customer interface device (140). Further, the stylist Z (120) views the look-book through a stylist display module (240) which is operatively coupled to the stylist chat module (200).

In addition, the customer X (110) showcases the personalised look-book created based on the recommendation of the stylist Z (120) to public. Also, the public may give suggestions or a review for the look-book created by the customer X (110).

Furthermore, the customer interface device (140) and the stylist interface device (170) are substantially similar to a system (10) of FIG. 1. Also, the selection module (130), the look-book module (220), the storage module (150), the customer X (110) and the stylist Y (120) are substantially similar to a selection module (20), a look-book module (70), a storage module (40), at least one customer (50) and a plurality of stylists (30) of FIG. 1 respectively. In addition, the customer chat module (190) and the stylist chat module (240) are substantially similar to a chat module (60) of FIG. 1. Further, the customer display module (230) and the stylist display module (240) are substantially similar to a display module (80) of FIG. 1.

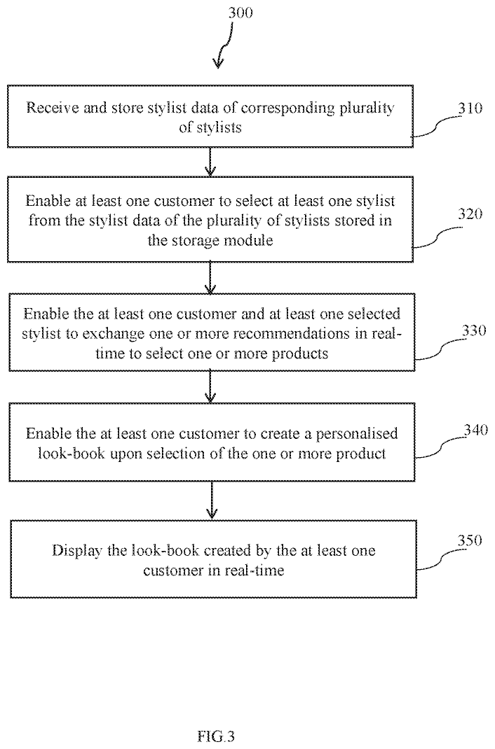

FIG. 3 is a flow chart representing steps involved in a method for creating a personalised look-book in accordance with an embodiment of the present disclosure. The method (300) includes receiving and storing stylist data of corresponding plurality of stylists in step 310. In one embodiment, receiving the stylist data may include receiving at least one of a name, an age, a place of living, a photo, a list of customers, years of experience, a collection of work or the like of the corresponding plurality of stylists. In another embodiment, the method (300) may also include receiving and storing customer data of the corresponding at least one customer. In such embodiment, receiving the customer data may include at least one of a name, an age, a place of living, at least one requirement, a photo or the like of the corresponding at least one customer.

In yet another embodiment, the method (300) may further include receiving and storing retailer data of corresponding one or more retailers. In such embodiment, receiving the retailer data may include receiving at least one of a name, at least one product or at least one service offered to the one or more users or the one or more customers by the corresponding one or more retailers. In one specific embodiment, storing the stylist data, storing the customer data and storing the retailer data may include storing the stylist data, the customer data and the retailer data in a memory of a storage module. In one exemplary embodiment, storing the stylist data, storing the customer data and storing the retailer data may include storing the stylist data, the customer data and the retailer data on a remote server such as a cloud server.

The method (300) also includes enabling at least one customer to get in contact with at least one stylist from the stylist data of the plurality of stylists stored in the storage module in step 320. In one embodiment, enabling the at least one customer to select the at least one stylist may include enabling the at least one customer to select the at least one stylist from the list of the plurality of stylists. Furthermore, the method (300) may include sending a request to the at least one stylist requesting to provide one or more recommendations on one or more products, wherein the at least one customer may be in need of one or more products which may be offered by the corresponding one or more retailers. In one specific embodiment, enabling the at least one customer to get in touch with the at least one stylist from the stylist data of the plurality of stylists stored in the storage module may include enabling the at least one customer to select the at least one stylist through the list of the plurality of stylists. In another embodiment, the at least one customer may be generated by the at least one stylist automatically based on a pre-defined data or otherwise.

Furthermore, the method (300) includes enabling the at least one customer and at least one selected stylist to exchange one or more recommendations in real-time to select one or more products in step 330. In one embodiment, the method (300) may also include enabling the at least one stylist selected by the at least one customer to accept the request which may be sent by the at least one customer for providing the one or more recommendations. In another embodiment, enabling the at least one customer and at least one selected stylist to exchange the one or more recommendations in real-time may include enabling the at least one customer and at least one selected stylist to exchange the one or more recommendations on the latest fashion in clothing industry. In one specific embodiment, the at least one customer may request the at least one stylist to provide the one or more recommendations to create a look-book for a latest fashion. In such embodiment, the at least one stylist may provide the one or more recommendation on the latest fashion in clothing industry in real-time to the at least one customer.

In one exemplary embodiment, the method (300) may further include enabling the at least one customer to select the one or more products based on the one or more recommendations of the at least one stylist. In such embodiment, enabling the at least one customer to select the one or more products may include enabling the at least one customer to select the one or more products from the corresponding one or more retailers in real-time.

The method (300) further includes enabling the at least one customer to create a personalised look-book upon selection of the one or more product in step 340. In one embodiment, enabling the at least one customer to create the personalised look-book may include enabling the at least one customer to create the look-book comprising a collection or a display of the latest fashion in the clothing industry. In one specific embodiment, enabling the at least one customer to create the look-book may include enabling the at least one customer to create the look-book based on the one or more recommendations from the at least one stylist.

Furthermore, the method (300) includes displaying the look-book created by the at least one customer in real-time in step 350. In one embodiment, displaying the look-book creation may include displaying the look-book creation to the at least one stylist in real-time. In one exemplary embodiment, the method (300) may also include displaying the look-book which may be created by the at least one customer based on the one or more recommendations of the at least one stylist to public or a plurality of other customers in real time. In one specific embodiment, the method (300) may further include receiving one or more suggestions from the plurality of other customers or the public for the look-book which may be created by the at least one customers.

Various embodiments of the system and method for a personalised look-book creation enable the system to provide a platform for the customers to select the stylist, the users, the one or more customers, the one or more retailers, the fashion community of a choice of the customer from anywhere across the world in real-time. The system also provides a platform for a real-time discussion between the customer and the stylist to create the look-book based on the latest trending fashion industry.

In addition, the system allows the customers to choose the products offered by the retailers in real-time through an interface and also enable the customers to showcase the products selected by the stylists in real-time and get feedback on the same. Also, the customers can have a personal chat with the interested stylist. Also, the system provides an omni-channel medium to couple with a plurality of offline retails.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (10) for a personalised look-book creation in real-time comprising:
a storage module (20) configured to receive and store stylist data of corresponding plurality of stylists (30);
a selection module (40) operatively coupled to the storage module (20), and configured to enable at least one customer (50) to get in contact with at least one stylist (30) from the stylist data of the plurality of stylists (30) stored in the storage module (20);
a chat module (60) operatively coupled to the selection module (40), and configured to enable the at least one customer (50) and at least one selected stylist (30) to exchange one or more recommendations in real-time to select one or more products, wherein the one or more products are offered by corresponding one or more retailers (65);
a look-book module (70) operatively coupled to the chat module (60), and configured to enable the at least one customer (50) to create a personalised look-book upon selection of the one or more products in real-time; and
a display interface (80) operatively coupled to the look-book module (70), and configured to display the personalised look-book created by the at least one customer (50) in real-time.

2. The system (10) as claimed in claim 1, wherein the storage module (20) is further configured to receive and store customer data of the corresponding at least one customer (50).

3. The system (10) as claimed in claim 1, wherein the chat module (60) is configured to exchange the one or more recommendations in real-time through an omni-channel medium.

4. The system (10) as claimed in claim 1, wherein selection module (40) is further configured to enable the at least one customer (50) to select the one or more products offered by the corresponding one or more retailers (65).

5. The system (10) as claimed in claim 1, wherein the display interface (80) comprises a hand-held device.

6. The system (10) as claimed in claim 1, wherein the system (10) is located on a cloud server.

7. A method (300) for creating a personalised look-book in real-time comprising:
receiving and storing stylist data of corresponding plurality of stylists; (310)
enabling at least one customer to get in contact with at least one stylist from the stylist data of the plurality of stylists stored in the storage module; (320)
enabling the at least one customer and at least one selected stylist to exchange one or more recommendations in real-time to select one or more products; (330)
enabling the at least one customer to create a personalised look-book upon selection of the one or more product in real-time; and (340)
displaying the look-book created by the at least one customer in real-time. (350)

8. The method (300) as claimed in claim in 7, wherein enabling the at least one customer to get in contact with the at least one stylist from the stylist data of the plurality of stylists stored in the storage module comprises:
enabling the at least one customer to select the at least one customer upon getting a choice to select; and
generating the at least one stylist recommendation for the at least one customer based on pre-defined set of data.

9. The method (300) as claimed in claim in 7, further comprising receiving and storing customer data of the corresponding at least one customer.
